(19) United States
(12) Patent Application Publication
(10) Pub. No.: US 2014/0064551 A1
(43) Pub. Date: Mar. 6, 2014

(54) CORRECTING ANOMALIES IN TERRAIN DATA

(71) Applicant: Stefan BIEGGER, Langnau am Albis (CH)

(72) Inventor: Stefan BIEGGER, Langnau am Albis (CH)

(73) Assignee: GOOGLE INC., Mountain View, CA (US)

(21) Appl. No.: 13/429,271

(22) Filed: Mar. 23, 2012

(51) Int. Cl. G06K 9/40

(52) U.S. Cl. 382/100

(57) ABSTRACT

Systems and methods for detecting anomalies and correcting errors in terrain data are provided. In some aspects, a method includes receiving a first terrain image. The method also includes automatically detecting a set of anomalies in the first terrain image. The method also includes generating a modified terrain image based on the first terrain image. The modified terrain image includes a visual indication of at least a subset of the set of anomalies in the first terrain image. The method also includes providing the modified terrain image for display. The method also includes receiving an input indicating that at least a portion of at least one anomaly in the set of anomalies includes an error. The method also includes generating a corrected terrain image by automatically correcting the error. The method also includes providing the corrected terrain image.

### FIELD

The subject technology generally relates to geographic and terrain modeling and, in particular, relates to correcting anomalies in terrain data.

### BACKGROUND

Internet-based providers of mapping and Earth viewing services have become very popular. These providers typically receive images of the terrain of different parts of the Earth from satellites, vehicle-based cameras and other sources. However, oftentimes these images include errors. Errors in mapping and Earth viewing services may diminish the value of the end-user experience or may prevent end-users from obtaining the information that the end-users seek. As the foregoing illustrates, a technique to detect and correct errors in terrain images may be desirable.

### SUMMARY

The disclosed subject matter relates to a computer-implemented method for detecting anomalies and correcting errors in terrain data. The method includes receiving a first terrain image. The method also includes automatically detecting a set of anomalies in the first terrain image. The method also includes generating a modified terrain image based on the first terrain image. The modified terrain image includes a visual indication of at least a subset of the set of anomalies in the first terrain image. The method also includes providing the modified terrain image for display. The method also includes receiving an input indicating that at least a portion of at least one anomaly in the set of anomalies includes an error. The method also includes generating a corrected terrain image by automatically correcting the error. The method also includes providing the corrected terrain image.

The disclosed subject matter further relates to a non-transitory computer-readable medium. The computer-readable medium includes instructions that, when executed by a computer, cause the computer to implement a method for detecting anomalies and correcting errors in terrain data. The instructions include code for automatically detecting a set of anomalies in a first terrain image. The instructions also include code for generating a modified terrain image based on the first terrain image. The modified terrain image includes an indication of at least a subset of the set of anomalies in the first terrain image. The instructions also include code for providing the modified terrain image for display. The instructions also include code for receiving an input indicating that at least a portion of at least one anomaly in the set of anomalies includes an error. The instructions also include code for generating a corrected terrain image by automatically correcting the error. The instructions also include code for providing the corrected terrain image.

The disclosed subject matter further relates to a system for detecting anomalies and correcting errors in terrain data. The system includes an anomaly detection module. The anomaly detection module is configured to receive a first terrain image. The anomaly detection module is also configured to automatically detect a set of anomalies in the first terrain image. The set of anomalies includes spikes, edges or linear features. The system also includes an anomaly inspection module. The anomaly inspection module is configured to receive the set of anomalies detected by the anomaly detection module. The anomaly inspection module is also configured to generate a modified terrain image based on the first terrain image. The modified terrain image includes a visual indication of at least a subset of the set of anomalies in the first terrain image. The anomaly inspection module is also configured to provide the modified terrain image for display. The anomaly inspection module is also configured to receive an input indicating that at least a portion of at least one anomaly in the set of anomalies includes an error. The system also includes an error correction module. The error correction module is configured to receive the at least the portion of the at least one anomaly that comprises the error. The error correction module is also configured to generate a corrected terrain image by automatically correcting the error. The error correction module is also configured to providing the corrected terrain image.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several aspects of the disclosed subject matter are set forth in the following figures.

FIG. 1 illustrates an example of a computer system configured to correct anomalies in terrain data.

FIG. 2 illustrates an example process by which anomalies in terrain data may be corrected.

FIGS. 3A-3C illustrate example stages of terrain image data as anomalies are detected and corrected in the terrain image data.

FIG. 4 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology relates to techniques for detecting anomalies and correcting errors in terrain data, for example Earth images. A server machine may receiving a first terrain image. The first terrain image may be received from a satellite, from an Earth-based vehicle taking terrain images, from a database of terrain images, or from any other source. The server machine may automatically detect a set of anomalies in the first terrain image. The anomalies may include spikes, edges, or linear features. The server machine may generate a modified terrain image based on the first terrain image. The modified terrain image may include a visual indication of at least a subset of the set of anomalies in the first terrain image. The visual indication of the subset of the set of anomalies may include color coding the anomalies. In one implementation, different colors codes may be assigned to each of spikes, edges, and linear features, e.g., spikes may be colored green, edges may be colored red, and linear features may be colored blue. The server machine may provide the modified terrain image for display on a client computing device. In response, the server machine may receive, from the client computing device, an input indicating that at least a portion of at least one anomaly in the set of anomalies comprises an error. The server machine may generate a corrected terrain image by automatically correcting the error, for example, via interpolation or inpainting techniques. The server machine may provide the corrected terrain image for display to a device running an Earth viewing program.

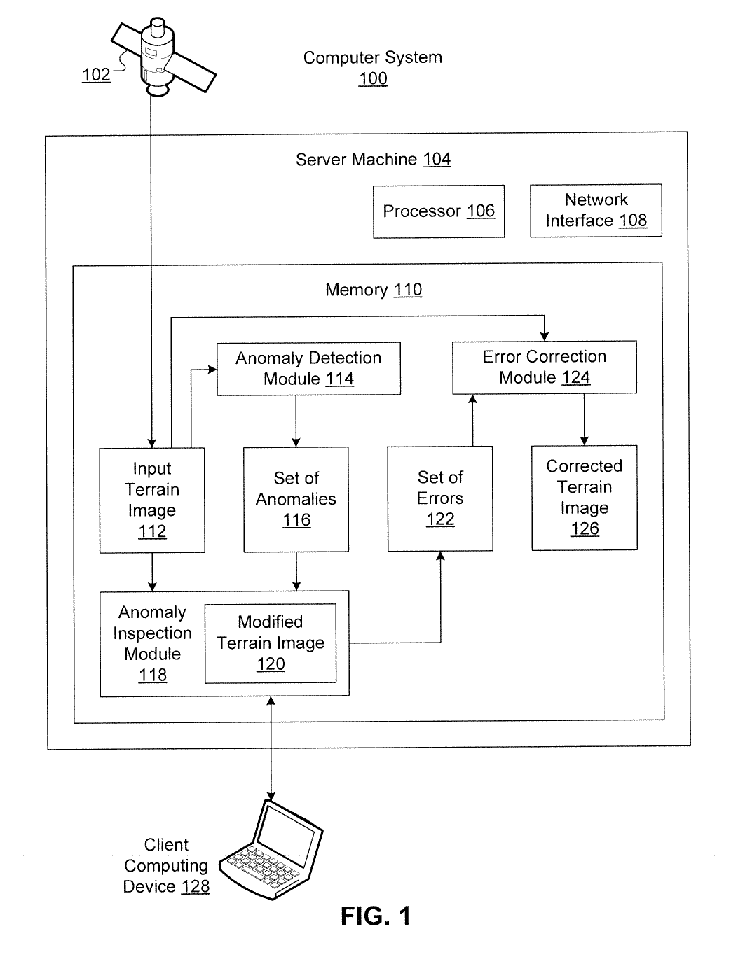

FIG. 1 illustrates an example of a computer system 100 configured to correct anomalies in terrain data.

As shown, the computer system 100 includes a satellite 102, a server machine 104, and a client computing device 128. The satellite 102 may be configured to transmit data to the server machine 104, for example, via a radio. The server machine 104 may be configured to communicate with the client computing device 128, for example, via a network. The network may be an Internet or a cellular network.

The satellite 102 may be any satellite configured to generate a terrain image and provide the terrain image to the server machine. In one implementation, the satellite 102 may be replaced with a terrain-based vehicle taking terrain images via a camera or any other source of one or more terrain images.

As shown, server machine 104 includes a processor 106, a network interface 108, and a memory 110. The processor 106 is configured to execute computer instructions that are stored in a computer-readable medium, for example, the memory 110. The processor 106 may be a central processing unit (CPU). The network interface 108 is configured to allow the server machine 104 to transmit and receive data in a network, for example, the Internet, an intranet, a local area network or a cellular network. The network interface 108 may include one or more network interface cards (NICs).

As illustrated, the memory 110 includes an input terrain image 112. The input terrain image 112 may be an Earth image received from the satellite 102. Alternatively, the input terrain image 112 may be received from an Earth-based vehicle, from a database of terrain images, or from any other source. The input terrain image 112 may include one or more anomalies, for example, spikes, edges, or linear features. Spikes may involve great changes in elevation over unit horizontal distance. For example, an elevation change at an angle of 60 degrees or more above or below the horizontal may be a spike. Edges may involve sharp or abrupt changes in shading or texture. Linear features may include geometric shapes, for example, rectangles, parallelograms, circles, or ellipses.

The memory 110 may also include an anomaly detection module 114. The anomaly detection module 114 may receive, a terrain image, e.g., the input terrain image 112, and detect one or more anomalies in the received terrain image. The anomaly detection module 114 may detect spikes by calculating an elevation difference between two neighboring tiles and determining that the elevation difference exceeds an elevation difference threshold. The elevation difference threshold may be based on the real-world distance between the locations represented in the tiles.

The anomaly detection module 114 may be configured to detect edges via a Sobel operator. The Sobel operator may involve calculating a gradient of an image intensity at a plurality of points in the terrain image, showing a rate of change of the image from light to dark or vice versa. The gradients may be used show how roughly or smoothly the image changes in a point. Points where the gradient exceeds a threshold magnitude may represent edges.

The anomaly detection module 114 may be configured to detect linear features via a Hough transform. The Hough transform may involve detecting a set of points, where the set of points are a part of an edge. The Hough transform may further involve using an accumulator array to determine the existence of a line segment or curve on the edge. For example, in a two-dimensional terrain image represented within a Cartesian coordinate system, a line that includes a line segment may be represented as y=mx+b, where the values of m and b may be determined. Several different lines through a plurality of the points in the set of points may be drawn, and the best fit line out of plural ones of the drawn lines may be selected. The best fit line may be determined based on the distance between the line and each point in at least a subset of the set of points along a perpendicular to the line. If the sum of the squares of the distances is less than a threshold, then the best fit line may be associated with the edge. Other geometric features may also be detected with the Hough transform. For example, a circle having a radius r and a center at the Cartesian coordinates (a, b) may be represented as (x−a)²+(y−b)²=r² and detected via a process similar to that described above for the line. The Sobel operator and the Hough transform are described in detail in other literature.

The memory 110 may also store a set of anomalies 116. The set of anomalies 116 may include the anomalies provided in the output of the anomaly detection module 114. The set of anomalies 116 may include spikes, edges, or linear features.

As shown, the memory further stores an anomaly inspection module 118. The anomaly inspection module 118 may receive as input a terrain image, e.g., input terrain image 112, and a set of anomalies within the terrain image, e.g., set of anomalies 116. Responsive to the input, the anomaly inspection module may generate a modified terrain image 120. The modified terrain image 120 may include a visual indication of at least a subset of the set of anomalies in the terrain image, e.g., all or a portion of the anomalies in the set of anomalies. The visual indication may include a color code associated with the anomalies in the subset. In one implementation, different colors may be associated with each of spikes, edges, and linear features. For example, spikes may be colored green, edges may be colored red, and linear features may be colored blue.

The anomaly inspection module 118 may provide the modified terrain image 120 for display. For example, the anomaly inspection module 118 may transmit the modified terrain image 120 to an external computer, e.g., the client computing device 128, where the modified terrain image 120 may be displayed to an end-user. The anomaly inspection module 118 may receive an input, e.g., from the external computer, e.g., the client computing device 128, indicating that at least a portion of at least one anomaly in the set of anomalies include an error. For example, an end-user of the external computer may draw a shape, e.g., a polygon, a circle, an ellipse, a line, or a curve, around the portion of the at least one anomaly that includes the error and transmit an indication of the shape to the anomaly inspection module 118 in the server machine 104. An output of the anomaly inspection module 118 may include a set of errors 122. The set of errors 122 may include errors identified by the user of the external computer and may be stored in the memory 110 of the server machine 104.

The memory 110 of the server machine 104 may also include an error correction module 124. The error correction module 124 may receive as input the at least the portion of the at least one anomaly that includes the error generated by the anomaly inspection module 118, which may be stored in the set of errors 122. The error correction module 124 may automatically correct at least one error that the error correction module 124 receives in the terrain image in which the anomalies and errors were detected, e.g., input terrain image 112. The error correction module 124 may correct the at least one error via interpolation or inpainting.

Interpolation may involve estimating the color or grayscale values for missing points in an image based on the adjacent points. According to one example, a function for color or grayscale values may be estimated based on the adjacent points, and the color or grayscale values of the missing points may be predicted according to the function.

Inpainting may involve estimating the color or grayscale values for missing points in an image based on the adjacent points. In one implementation of inpainting, differential equations, e.g., Laplace's equation with Dirichlet boundary conditions for continuity may be applied. Alternatively, the inpainting may be completed based on the isophote direction in the adjacent points. In another implementation, a clone module or a texture synthesis module may be applied to estimate the color or grayscale values of the missing points in the image. Interpolation and inpainting are described in more detail in other literature. The output of the error correction module 124 may include a corrected terrain image 126. The corrected terrain image 126 may be stored in the memory 110 of the server machine 104 and may be provided for display when requested via a mapping or Earth viewing program running on the server machine 104 or on an external computer, e.g., client computing device 128.

The client computing device 128 may be any computing device capable presenting terrain images and receiving input regarding the positions of errors in the terrain images, for example via a web browser or via a specialized application. The client computing device may be a laptop computer, a desktop computer, a mobile phone, a personal digital assistant (PDA), a tablet computer, a netbook, a physical machine or a virtual machine. The client computing device may include one or more of a keyboard, a mouse, a display, or a touch screen. Persons skilled in the art will recognize other devices that could implement the functionalities of the client computing device 128 and other components that may be included in the client computing device 128.

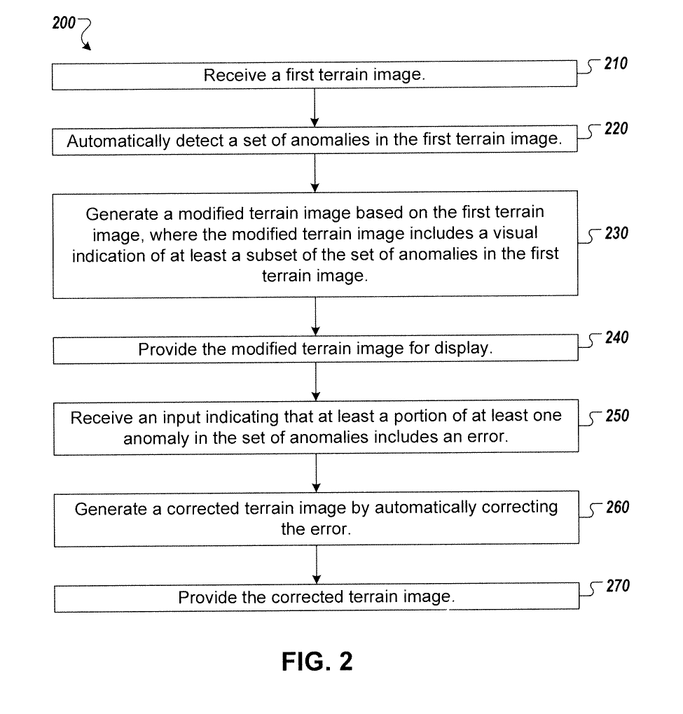

FIG. 2 illustrates an example process 200 by which anomalies in terrain data may be corrected.

The process 200 begins at step 210, where the server machine receives a first terrain image. The first terrain image may be received from a satellite, from an Earth-based vehicle, from a database of terrain images, or from any other source.

According to step 220, the server machine automatically detects a set of anomalies in the first terrain image. The set of anomalies may include, for example, spikes, edges, or linear features. Spikes may involve great changes in elevation over unit horizontal distance. For example, an elevation change at an angle of 60 degrees or more above or below the horizontal may be a spike. Edges may involve sharp or abrupt changes in shading or texture. Linear features may include geometric shapes, for example, rectangles, parallelograms, circles, or ellipses.

Detecting spikes may involve calculating an elevation difference between two neighboring tiles and determining that the elevation difference exceeds an elevation difference threshold. The elevation difference threshold may be based on the real-world distance between the locations represented in the tiles.

Detecting edges may be accomplished via a Sobel operator. The Sobel operator may involve calculating a gradient of an image intensity at a plurality of points in the terrain image, showing a rate of change of the image from light to dark or vice versa. The gradients may be used show how roughly or smoothly the image changes in a point. Points where the gradient exceeds a threshold magnitude may represent edges.

Linear features may be detected via a Hough transform. The Hough transform may involve detecting a set of points, where the set of points are a part of an edge. The Hough transform may further involve using an accumulator array to determine the existence of a line segment or curve on the edge. For example, in a two-dimensional terrain image represented within a Cartesian coordinate system, a line that includes a line segment may be represented as y=mx+b, where the values of m and b may be determined. Several different lines through a plurality of the points in the set of points may be drawn, and the best fit line out of plural ones of the drawn lines may be selected. The best fit line may be determined based on the distance between the line and each point in at least a subset of the set of points along a perpendicular to the line. If the sum of the squares of the distances is less than a threshold, then the best fit line may be associated with the edge. Other geometric features may also be detected with the Hough transform. For example, a circle a circle having a radius r and a center at the Cartesian coordinates (a, b) may be represented as (x−a)²+(y−b)²=r² and detected via a process similar to that described above for the line. The Sobel operator and the Hough transform are described in detail in other literature.

According to step 230, the server machine generates a modified terrain image based on the first terrain image. The modified terrain image may include a visual indication of at least a subset of the set of anomalies in the first terrain image, e.g., all or a portion of the anomalies in the set of anomalies. The visual indication may include a color code associated with the anomalies in the subset. In one implementation, different colors may be associated with each of spikes, edges, and linear features. For example, spikes may be colored green, edges may be colored red, and linear features may be colored blue.

According to step 240, the server machine provides the modified terrain image for display. For example, the server machine may transmit the modified terrain image to a client computing device, where the modified terrain image may be displayed to an end-user.

According to step 250, the server machine receives an input that at least a portion of at least one anomaly in the set of anomalies includes an error. The input may come from the client computing device. For example, the end-user of the client computing device may draw a shape, e.g., a polygon, a circle, an ellipse, a line, or a curve, around the portion of the at least one anomaly that includes the error and transmit an indication of the shape to the server machine.

According to step 260, the server machine generates a corrected terrain image by automatically correcting the error received in the input. The server machine may correct the at least one error via interpolation or inpainting.

Interpolation may involve estimating the color or grayscale values for missing points in an image based on the adjacent points. According to one example, a function for color or grayscale values may be estimated based on the adjacent points, and the color or grayscale values of the missing points may be predicted according to the function.

Inpainting may involve estimating the color or grayscale values for missing points in an image based on the adjacent points. In one implementation of inpainting, differential equations, e.g., Laplace's equation with Dirichlet boundary conditions for continuity may be applied. Alternatively, the inpainting may be completed based on the isophote direction in the adjacent points. In another implementation, a clone module or a texture synthesis module may be applied to estimate the color or grayscale values of the missing points in the image. Interpolation and inpainting are described in more detail in other literature.

According to step 270, the server machine provides the corrected terrain image. The corrected terrain image may be stored in the memory of the server machine and may be provided for display when requested via a mapping or Earth viewing program running on the server machine or on an external computer.

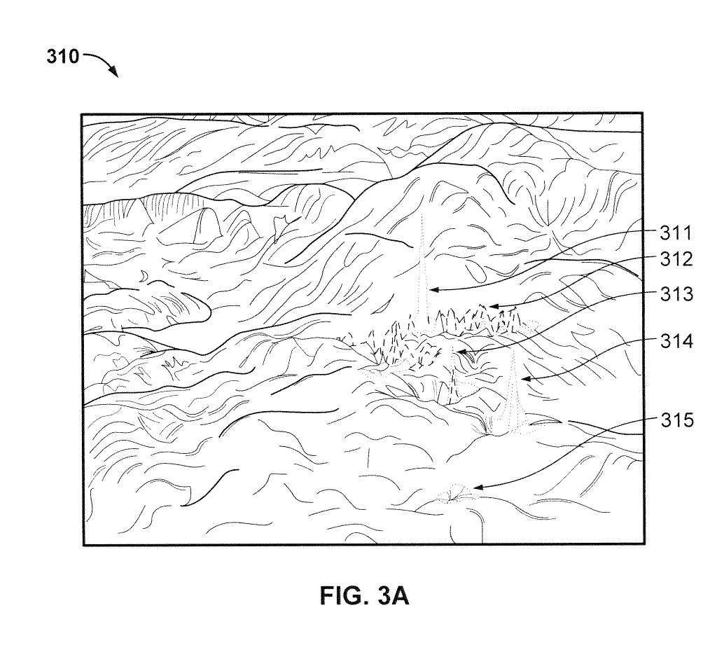

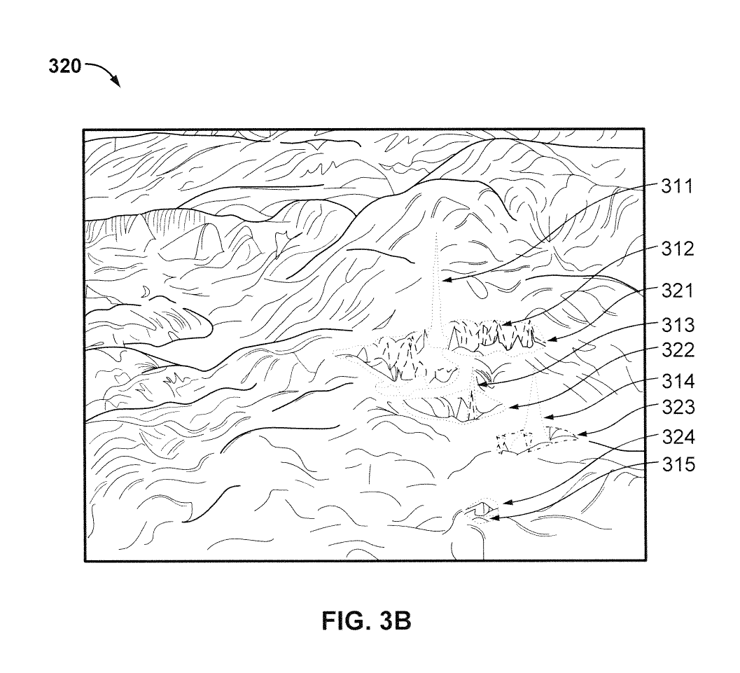

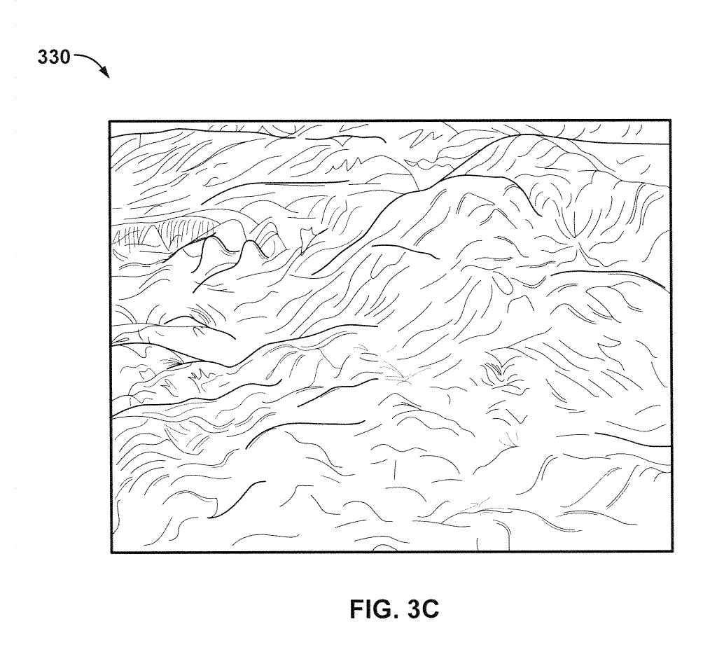

FIGS. 3A-3C illustrate example stages of terrain image data 310, 320, and 330 as anomalies are detected and corrected in the terrain image data.

FIG. 3A illustrates an example terrain image 310 including an indication of a set of anomalies. The image that includes the indication of the set of anomalies may be, for example, the modified terrain image 120 of FIG. 1.

As shown, the image 310 includes spikes 311, 313, 314, or 315 that involve great changes in elevation over unit horizontal distance and edges 312 that involve great changes in elevation over unit horizontal distance. As illustrated, the spikes 311, 313, 314, or 315 are expressed with dotted lines and the edges 312 are expressed with dashed lines. In an alternative implementation (not illustrated), the spikes, edges, or linear features, if any, may be color coded instead of or in addition to being expressed with dotted or dashed lines. The spikes 311, 313, 314, or 315 and edges 312 may be detected automatically. As set forth above, spikes, e.g., spikes 311, 313, 314, or 315, may be detected by determining that an elevation difference between two adjacent tiles exceeds an elevation difference threshold. Edges, e.g., edges 312, may be detected via the Sobel operator. Linear features (not illustrated) may be detected via the Hough transform.

The image 310 may be presented to an end-user, e.g., via a browser or an application running on client computing device 128. The end-user may indicate whether the portions of the image 310 that include anomalies 311, 312, 313, 314, or 315 include errors.

FIG. 3B illustrates an example terrain image 320 indicating positions of errors. The indications 321, 322, 323, and 324 of the positions of the errors may be generated by an end-user.

As shown, the image 320 includes the spikes 311, 313, 314, and 315 and the edges 312 of the image 310 depicted in FIG. 3A. The image 320 also includes indications of positions of errors 321, 322, 323, or 324. The indications 321, 322, 323, and 324 may be entered by an end-user of a computer, e.g., client computing device 128. As illustrated, the indications 321, 322, 323, or 324 include dotted lines. However, in an alternative implementation, the indications may include dashed lines, continuous lines, or color coded regions. It should be noted that the end-user indicated that all of the anomalies 311, 312, 313, 314, and 315 are errors. However, in an alternative implementation, the end-user may conclude that one or more anomalies are not errors. Anomalies that are not errors may not be corrected in the corrected terrain image 330, discussed below.

FIG. 3C illustrates an example corrected terrain image 330. The corrected terrain image 330 may be generated, for example, by applying the error correction module 124 in FIG. 1 to the errors 321, 322, 323, or 324 of the terrain image 320 in FIG. 3B.

As shown, the corrected terrain image 330 has been corrected at the positions of the errors 321, 322, 323, or 324 of FIG. 3B. The corrected terrain image 330 may have been corrected at the positions 321, 322, 323, or 324 of image 320 via interpolating or inpainting, as described above. As a result, the corrected terrain image 330 may lack the spikes 311, 313, 314, and 315, and the edges 312 of images 310 and 320. While only spikes and edges have been corrected in images 310, 320, and 330, other types of anomalies, for example, linear features, may also be corrected in accordance with the subject technology.

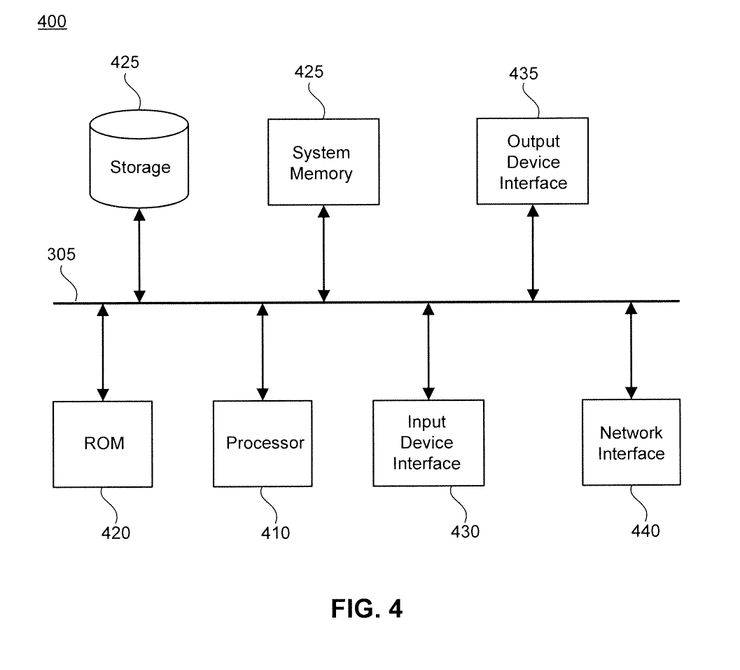

FIG. 4 conceptually illustrates an electronic system 400 with which some implementations of the subject technology are implemented. For example, one or more of the server machine 104 or the client computing device 128 may be implemented using the arrangement of the electronic system 400. The electronic system 400 can be a computer (e.g., a mobile phone, PDA), or any other sort of electronic device. Such an electronic system includes various types of computer readable media and interfaces for various other types of computer readable media. Electronic system 400 includes a bus 405, processing unit(s) 410, a system memory 415, a read-only memory 420, a permanent storage device 425, an input device interface 430, an output device interface 435, and a network interface 440.

The bus 405 collectively represents all system, peripheral, and chipset buses that communicatively connect the numerous internal devices of the electronic system 400. For instance, the bus 405 communicatively connects the processing unit(s) 410 with the read-only memory 420, the system memory 415, and the permanent storage device 425.

From these various memory units, the processing unit(s) 410 retrieves instructions to execute and data to process in order to execute the processes of the subject technology. The processing unit(s) can be a single processor or a multi-core processor in different implementations.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some implementations of the subject technology use a mass-storage device (for example a magnetic or optical disk and its corresponding disk drive) as the permanent storage device 425.

Other implementations use a removable storage device (for example a floppy disk, flash drive, and its corresponding disk drive) as the permanent storage device 425. Like the permanent storage device 425, the system memory 415 is a read-and-write memory device. However, unlike storage device 425, the system memory 415 is a volatile read-and-write memory, such a random access memory. The system memory 415 stores some of the instructions and data that the processor needs at runtime. In some implementations, the processes of the subject technology are stored in the system memory 415, the permanent storage device 425, or the read-only memory 420. For example, the various memory units include instructions for correcting anomalies in terrain data in accordance with some implementations. From these various memory units, the processing unit(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interfaces 435 enables, for example, the display of images generated by the electronic system 400. Output devices used with output device interface 435 include, for example, printers and display devices, for example cathode ray tubes (CRT) or liquid crystal displays (LCD). Some implementations include devices for example a touchscreen that functions as both input and output devices.

Finally, as shown in FIG. 4, bus 405 also couples electronic system 400 to a network (not shown) through a network interface 440. In this manner, the electronic system 400 can be a part of a network of computers (for example a local area network (“LAN”), a wide area network (“WAN”), or an Intranet, or a network of networks, for example the Internet. Any or all components of electronic system 400 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method for detecting anomalies and correcting errors in terrain data, the method comprising:
receiving a first terrain image;
automatically detecting a set of anomalies in the first terrain image, the set of anomalies including one or more linear features corresponding to geometric shapes, the linear features being detected via a mathematical transform;
generating a modified terrain image based on the first terrain image, wherein the modified terrain image comprises a visual indication of at least a subset of the set of anomalies in the first terrain image;
providing the modified terrain image for display;
receiving an input indicating that at least a portion of at least one anomaly in the set of anomalies comprises an error;
generating a corrected terrain image by automatically correcting the error; and
providing the corrected terrain image.

2. The method of claim 1, wherein the set of anomalies includes spikes or edges.

3. The method of claim 2, wherein the spikes are detected by:
assigning a first elevation to a first tile in the first terrain image;
determining that a second tile in the first terrain image has a second elevation, wherein the second tile is immediately adjacent to the first tile; and
determining that a difference between the first elevation and the second elevation exceeds an elevation difference threshold.

4. The method of claim 2, wherein the edges are detected via a Sobel operator.

5. The method of claim 1, wherein the mathematical transform for detecting the linear features comprises a Hough transform.

6. The method of claim 2, wherein the visual indication of the at least the subset of the set of anomalies in the first terrain image comprises a color code.

7. The method of claim 6, wherein a first color is assigned to the spikes, a second color, different from the first color, is assigned to the edges, and a third color, different from the first color and the second color, is assigned to the linear features.

8. The method of claim 1, wherein the input indicating that the at least the portion of the at least one anomaly in the set of anomalies comprises the error comprises one or more polygons, circles, ellipses, lines, or curves surrounding the at least the portion of the at least one anomaly.

9. The method of claim 1, wherein the automatically correcting the error comprises interpolating or inpainting.

10. A non-transitory computer-readable medium comprising instructions that, when executed by a computer, cause the computer to:
automatically detect a set of anomalies in a first terrain image, the set of anomalies including one or more linear features corresponding to geometric shapes, the linear features being detected via a mathematical transform;
generate a modified terrain image based on the first terrain image, wherein the modified terrain image comprises an indication of at least a subset of the set of anomalies in the first terrain image;
provide the modified terrain image for display;
receive an input indicating that at least a portion of at least one anomaly in the set of anomalies comprises an error;
generate a corrected terrain image by automatically correcting the error; and
provide the corrected terrain image.

11. The non-transitory computer-readable medium of claim 10, wherein the set of anomalies includes spikes or edges.

12. The non-transitory computer-readable medium of claim 11, wherein the instructions to detect the spikes include instructions that, when executed by the computer, cause the computer to:
assign a first elevation to a first tile in the first terrain image;
determine that a second tile in the first terrain image has a second elevation, wherein the second tile is immediately adjacent to the first tile; and
determine that a difference between the first elevation and the second elevation exceeds an elevation difference threshold.

13. The non-transitory computer-readable medium of claim 11, wherein the edges are detected via a Sobel operator.

14. The non-transitory computer-readable medium of claim 10, wherein the mathematical transform for detecting the linear features comprises a Hough transform.

15. The non-transitory computer-readable medium of claim 11, wherein the indication of the at least the subset of the set of anomalies in the first terrain image comprises a color code.

16. The non-transitory computer-readable medium of claim 15, wherein a first color is assigned to the spikes, a second color, different from the first color, is assigned to the edges, and a third color, different from the first color and the second color, is assigned to the linear features.

17. The non-transitory computer-readable medium of claim 10, wherein the input indicating that the at least the portion of the at least one anomaly in the set of anomalies comprises the error comprises one or more polygons, circles, ellipses, lines, or curves surrounding the at least the portion of the at least one anomaly.

18. The non-transitory computer-readable medium of claim 10, wherein the automatically correcting the error comprises interpolating or inpainting.

19. A system comprising:
one or more processors;
a memory;
an anomaly detection software module residing within the memory and storing instructions to:
receive a first terrain image, and
automatically detect a set of anomalies in the first terrain image, wherein the set of anomalies includes spikes, edges or linear features, the linear features corresponding to geometric shapes, and the linear features being detected via a mathematical transform;
an anomaly inspection software module residing within the memory and storing instructions to:
receive the set of anomalies detected by the anomaly detection module,
generate a modified terrain image based on the first terrain image, wherein the modified terrain image comprises a visual indication of at least a subset of the set of anomalies in the first terrain image,
provide the modified terrain image for display;
receive an input indicating that at least a portion of at least one anomaly in the set of anomalies comprises an error; and
an error correction software module residing within the memory and storing instructions to:
receive the at least the portion of the at least one anomaly that comprises the error;
generate a corrected terrain image by automatically correcting the error, and
provide the corrected terrain image.

20. The system of claim 19, wherein the visual indication of the at least the subset of the set of anomalies in the first terrain image comprises a color code, further wherein a first color is assigned to the spikes, a second color, different from the first color, is assigned to the edges, and a third color, different from the first color and the second color, is assigned to the linear features.

21. The method of claim 1, wherein the geometric shapes include one or more of a rectangle, a parallelogram, a circle, or an ellipse.

22. The method of claim 1, wherein the mathematical transform for detecting the linear features involves a calculation with an accumulator array.
